(19) United States
(12) Patent Application Publication
(10) Pub. No.: US 2022/0300265 A1
(43) Pub. Date: Sep. 22, 2022

(54) METHOD AND SYSTEM FOR CONTINUOUS INTEGRATION AND CONTINUOUS DEPLOYMENT OF APPLICATIONS

(71) Applicant: JPMorgan Chase Bank, N.A., New York, NY (US)

(72) Inventors: Sreeja P PUROHIT, Mumbai (IN); Rajeev Kumar BALASUBRAMANIAN, Middletown, DE (US); Sanjay SOLANKI, Thane West (IN)

(73) Assignee: JPMorgan Chase Bank, N.A., New York, NY (US)

(21) Appl. No.: 17/204,309

(22) Filed: Mar. 17, 2021

(51) Int. Cl. G06F 8/60; G06F 8/41; G06F 11/36

(52) U.S. Cl. CPC G06F 8/60; G06F 8/44; G06F 11/3688

(57) ABSTRACT

A method for integrating applications into a software suite is provided. The method includes: receiving a first code set that corresponds to a first application; obtaining an approval of the first code set; compiling the first code set in order to generate a module that is executable within the software suite; determining at least one target environment within the software suite for deployment of the first application; and deploying the executable module to each of the at least one target environment. An automated testing process and an automated validation process are applicable to deployed modules.

### BACKGROUND

### 1. Field of the Disclosure

This technology generally relates to methods and systems for providing continuous integration and continuous deployment of applications within a platform that hosts a complex software suite.

### 2. Background Information

In a large organization, the availability and accessibility of applications within a software suite provides an advantage of increasing efficiency by facilitating the use of a common set of tools to members of the organization. In this aspect, the benefits of newly developed applications may be widely realized.

When a new application is developed, there is a need to integrate and deploy the newly developed application into the structure of the existing software suite, in order to avoid unforeseen disruptions. In addition, for a large software suite, the volume of newly developed applications may be such that manually performing such integrations and deployments is impractical.

Accordingly, there is a need for a method for automating a continuous integration and continuous deployment of applications into a large and complex software suite.

### SUMMARY

The present disclosure, through one or more of its various aspects, embodiments, and/or specific features or sub-components, provides, inter alia, various systems, servers, devices, methods, media, programs, and platforms for providing continuous integration and continuous deployment of applications within a platform that hosts a complex software suite.

According to an aspect of the present disclosure, a method for providing continuous integration and continuous deployment of applications within a platform that hosts a complex software suite is provided. The method is implemented by at least one processor. The method includes: receiving, by the at least one processor, a first code set that corresponds to a first application; obtaining, by the at least one processor, an approval that relates to the first code set, compiling, by the at least one processor, the first code set in order to generate a module that is executable within the software suite; determining, by the at least one processor, at least one target environment within the software suite for deployment of the first application; and deploying, by the at least one processor, the executable module to each of the at least one target environment.

The software suite may be hosted on an HP NonStop platform.

The deploying may include using a Jenkins Pipeline to execute the deployment.

The software suite may be stored in a Bitbucket repository.

The method may further include: after receiving the first code set and before obtaining the approval, using an NSGit tool to forward the received first code set to the Bitbucket repository.

The obtaining of the approval may include using the Bitbucket repository to facilitate a peer review process.

The method may further include executing an automated testing procedure for administering a test with respect to the deployed module.

The executing of the automated testing procedure may include using a LeanFT tool to perform the execution of the automated testing procedure.

The method may further include validating the deployed module based on a result of the execution of the automated testing procedure.

According to another exemplary embodiment, a computing apparatus for integrating applications into a software suite is provided. The computing apparatus includes a processor; a memory; and a communication interface coupled to each of the processor and the memory. The processor is configured to: receive, via the communication interface, a first code set that corresponds to a first application; obtain an approval that relates to the first code set; compile the first code set in order to generate a module that is executable within the software suite; determine at least one target environment within the software suite for deployment of the first application; and deploy the executable module to each of the at least one target environment.

The software suite may be hosted on an HP NonStop platform.

The processor may be further configured to use a Jenkins Pipeline to execute the deployment.

The memory may include a Bitbucket repository. The software suite may be stored in the Bitbucket repository.

The processor may be further configured to: after receiving the first code set and before obtaining the approval, use an NSGit tool to forward the received first code set to the Bitbucket repository.

The processor may be further configured to obtain the approval by using the Bitbucket repository to facilitate a peer review process.

The processor may be further configured to execute an automated testing procedure for administering a test with respect to the deployed module.

The processor may be further configured to use a LeanFT tool to perform the execution of the automated testing procedure.

The processor may be further configured to validate the deployed module based on a result of the execution of the automated testing procedure.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing continuous integration and continuous deployment of applications within a platform that hosts a complex software suite.

FIG. 4 is a flowchart of an exemplary process for implementing a method for providing continuous integration and continuous deployment of applications within a platform that hosts a complex software suite.

FIG. 5 is a diagram that illustrates a set of tools that are usable for executing a method for providing continuous integration and continuous deployment of applications within a platform that hosts a complex software suite, according to an exemplary embodiment.

FIG. 6 is an architectural overview diagram for a system for providing continuous integration and continuous deployment of applications within a platform that hosts a complex software suite, according to an exemplary embodiment.

FIG. 7 is a data flow diagram of a deployment pipeline that is usable for executing a method for providing continuous integration and continuous deployment of applications within a platform that hosts a complex software suite, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

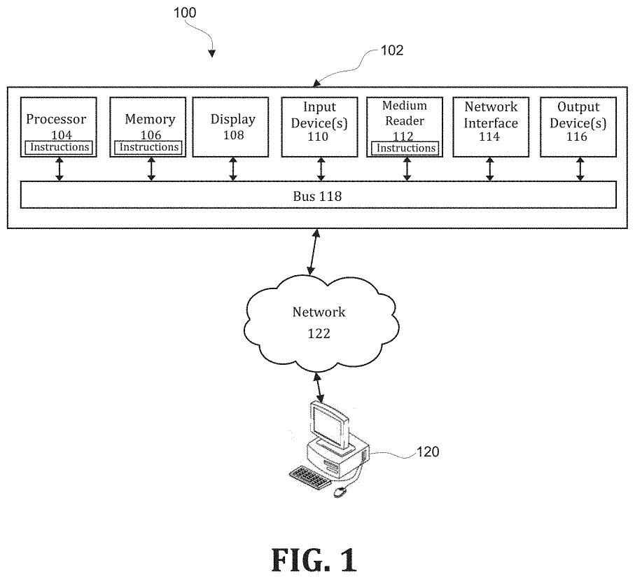

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing continuous integration and continuous deployment of applications within a platform that hosts a complex software suite.

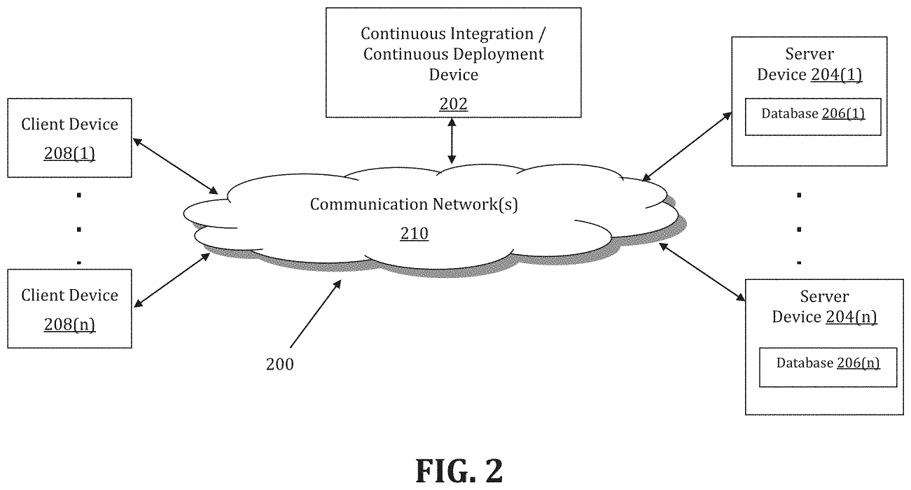

Referring to FIG. 2, a schematic of an exemplary network environment 200 for implementing a method for providing continuous integration and continuous deployment of applications within a platform that hosts a complex software suite is illustrated. In an exemplary embodiment, the method is executable on any networked computer platform, such as, for example, a personal computer (PC).

The method for providing continuous integration and continuous deployment of applications within a platform that hosts a complex software suite may be implemented by a Continuous Integration/Continuous Deployment (CICD) device 202. The CICD device 202 may be the same or similar to the computer system 102 as described with respect to FIG. 1. The CICD device 202 may store one or more applications that can include executable instructions that, when executed by the CICD device 202, cause the CICD device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the CICD device 202 itself, may be located in virtual server(s) running in a cloud-based computing environment rather than being tied to one or more specific physical network computing devices. Also, the application(s) may be running in one or more virtual machines (VMs) executing on the CICD device 202. Additionally, in one or more embodiments of this technology, virtual machine(s) running on the CICD device 202 may be managed or supervised by a hypervisor.

In the network environment 200 of FIG. 2, the CICD device 202 is coupled to a plurality of server devices 204(1)-204(n) that hosts a plurality of databases 206(1)-206(n), and also to a plurality of client devices 208(1)-208(n) via communication network(s) 210. A communication interface of the CICD device 202, such as the network interface 114 of the computer system 102 of FIG. 1, operatively couples and communicates between the CICD device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the CICD device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and CICD devices that efficiently implement a method for providing continuous integration and continuous deployment of applications within a platform that hosts a complex software suite.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The CICD device 202 may be a standalone device or integrated with one or more other devices or apparatuses, such as one or more of the server devices 204(1)-204(n), for example. In one particular example, the CICD device 202 may include or be hosted by one of the server devices 204(1)-204(n), and other arrangements are also possible. Moreover, one or more of the devices of the CICD device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the CICD device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to software suite architectures and code repositories.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the CICD device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the CICD device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the CICD device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the CICD device 202, the server devices 204(1)-204(n), or the client devices 208(1)-208(n), for example, may be configured to operate as virtual instances on the same physical machine. In other words, one or more of the CICD device 202, the server devices 204(1)-204(n), or the client devices 208(1)-208(n) may operate on the same physical device rather than as separate devices communicating through communication network(s) 210. Additionally, there may be more or fewer CICD devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

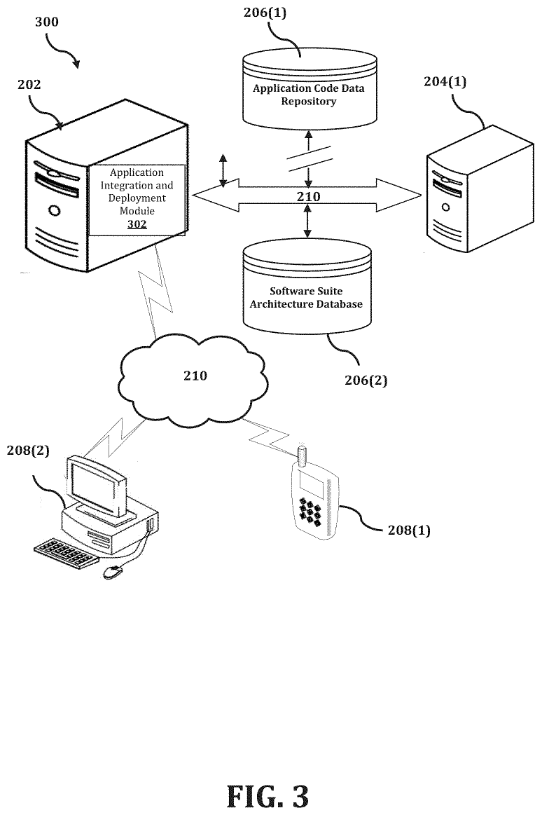

The CICD device 202 is described and illustrated in FIG. 3 as including a application integration and deployment module 302, although it may include other rules, policies, modules, databases, or applications, for example. As will be described below, the application integration and deployment module 302 is configured to implement a method for providing continuous integration and continuous deployment of applications within a platform that hosts a complex software suite.

An exemplary process 300 for implementing a mechanism for providing continuous integration and continuous deployment of applications within a platform that hosts a complex software suite by utilizing the network environment of FIG. 2 is illustrated as being executed in FIG. 3. Specifically, a first client device 208(1) and a second client device 208(2) are illustrated as being in communication with CICD device 202. In this regard, the first client device 208(1) and the second client device 208(2) may be “clients” of the CICD device 202 and are described herein as such. Nevertheless, it is to be known and understood that the first client device 208(1) and/or the second client device 208(2) need not necessarily be “clients” of the CICD device 202, or any entity described in association therewith herein. Any additional or alternative relationship may exist between either or both of the first client device 208(1) and the second client device 208(2) and the CICD device 202, or no relationship may exist.

Further, CICD device 202 is illustrated as being able to access a application code data repository 206(1) and a software suite architecture database 206(2). The application integration and deployment module 302 may be configured to access these databases for implementing a method for providing continuous integration and continuous deployment of applications within a platform that hosts a complex software suite.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the CICD device 202 via broadband or cellular communication. Of course, these embodiments are merely exemplary and are not limiting or exhaustive.

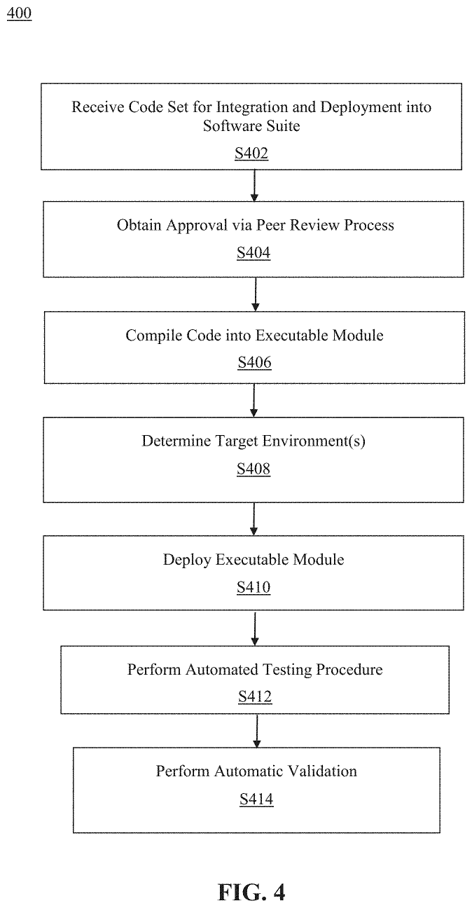

Upon being started, the application integration and deployment module 302 executes a process for providing continuous integration and continuous deployment of applications within a platform that hosts a complex software suite. An exemplary process for providing continuous integration and continuous deployment of applications within a platform that hosts a complex software suite is generally indicated at flowchart 400 in FIG. 4.

In process 400 of FIG. 4, at step S402, the application integration and deployment module 302 receives a set of code that corresponds to an application that is intended for integration and deployment in the software suite. In an exemplary embodiment, the software suite is hosted on an HP NonStop platform and is stored in a Bitbucket repository, and the development of the set of code is performed in a NonStop Development Environment for Eclipse (NSDEE). In addition, an NSGit tool may be provided for forwarding the received code set to the Bitbucket repository.

At step S404, the application integration and deployment module 302 obtains an approval for the received set of code. In an exemplary embodiment, Bitbucket also acts as a peer review tool by facilitating a peer review process that results in the approval of the code set.

At step S406, the application integration and deployment module 302 compiles the code set in order to generate a module that is executable within the software suite. At step S408, the application integration and deployment module 302 determines one or more target environments within the software suite to which the module is to be deployed. Then, at step S410, the application integration and deployment module 302 deploys the executable module to the target environments. In an exemplary embodiment, the deployment is performed by using a Jenkins Pipeline.

At step S412, the application integration and deployment module 302 executes an automated testing procedure for administering a test on the deployed module. In an exemplary embodiment, the automated testing procedure may be implemented by using a LeanFT tool. Then, at step S414, the application integration and deployment module 302 automatically validates the module based on a result of the testing procedure.

In an exemplary embodiment, Agile software development practices in conjunction with the use of CICD device 202 and the application integration and deployment module 302 has improved the efficiency of a project, and they also facilitate in leveraging the development operations (DevOps) communities in order to deliver features into production faster and in an efficient way. In the NonStop world, it has always been challenging to adopt such continuous integration and continuous delivery due to multi-tier system firewalls and the underlying operating system.

Challenges: 1) Code management; 2) dependency on release management for coordinated release/periodic release to do code promotion manually; 3) manual tollgate scans; 4) lack of robustness in code review process; 5) difficulties with automated scripts and automated file testing (AFT); 6) dependency on cross block team; 7) location of repository may lead to loss of code during destructive event.

Solution: In an exemplary embodiment, DevOps for HP NonStop requires the following: 1) Modern Integrated Development Environments (IDEs), such as, for example, NonStop Development Environment for Eclipse (NSDEE); 2) automated testing at all levels; 3) automated continuous integration (CI) pipeline; 4) automated continuous delivery (CD) pipeline; 5) software code management (SCM) that supports concurrent development with merge capabilities; 6) cross platform testing tools with automation capabilities, and 7) cross platform data gathering, masking and simplification tools.

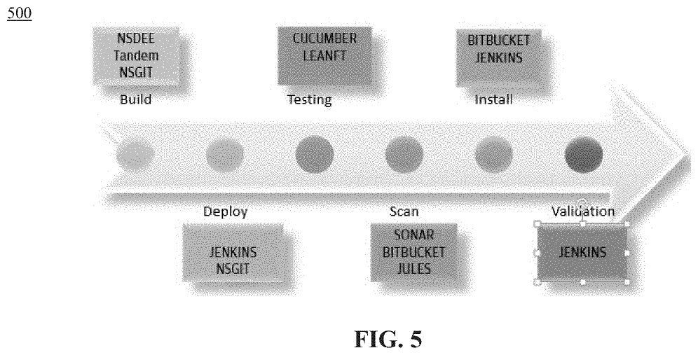

FIG. 5 is a diagram 500 that illustrates a set of tools that are usable for executing a method for providing continuous integration and continuous deployment of applications within a platform that hosts a complex software suite, according to an exemplary embodiment.

IDE tools: NSDEE provides an Eclipse-based IDE to streamline NonStop application development. An intuitive and easy-to-use interface provides the essentials of modern application development, testing, and maintenance.

NSGit: NSGit is a third party vendor tool, which acts as a Guardian front end for Git, which is a distributed version-control system for tracking changes in any set of files. Git runs in the HP NonStop Open System Services (OSS) space and needs the OSS file system to run properly. Git is useful for managing ASCII text files and binary files such as Word documents. NSGit allows Guardian components to be stored in Git, thereby facilitating management of many other file types, such as EDIT files, ENSCRIBE files, Data Definition Language (DDL) dictionaries, code 100, code 500, 700, 800 files, SCOBOL source and compiled POBJ requesters. NSGit is not open source, but instead is licensed under a commercial license.

Jenkins: Jenkins is an open source automation server written in Java. Jenkins helps to automate the non-human part of the software development process, with continuous integration and facilitating technical aspects of continuous delivery. Jenkins is a server-based system that runs in servlet containers such as Apache Tomcat.

Bitbucket—for Repository, Peer Review Process and Code Scans: Bitbucket is a web-based version control repository hosting service that is widely used for source code and development projects that use either Mercurial or Git control systems. Bitbucket integrates with other software such as Jira and Confluence.

Jules—for Sonar and Source Service Access Point (SSAP) code scans: Jules provides a central service to build, test, scan and deploy applications. The Jules global library integrates with various software tools, while Pattern Builds simplify code to less than 20 lines of configuration.

LeanFT—for automated testing process: LeanFT is a powerful functional testing tool which has been developed specifically for Agile and DevOps software development methods. The general user base for LeanFT is quality assurance (QA) personnel, business analysts, testers, and subject matter experts. The LeanFT solution is most suitable for Agile, DevOps and continuous testing teams.

Tools Connectivity & Flow: In an exemplary embodiment, the following sequence is executed: 1) Source code is built on Tandem/NSDEE (i.e., IDE tool) and via NSGIT commands, the source code is committed and pushed to GitHub (i.e., Bitbucket). 2) The source code is reviewed, approved, and merged to a release branch. 3) A time trigger happens at Jenkins, which pulls the source code from the release branch, and a macro that is being run by Jenkins Pipeline compiles the code in Tandem using the DDL. 4) The compiled code is pushed to the release branch and the code branch. The compiled code pushed to the release branch contains both source code and object code, and the compiled code pushed to the code branch contains only object code. 5) The code branch is used to deploy the code in various environments. 6) Post hook is set up in the Bitbucket for automated scanning.

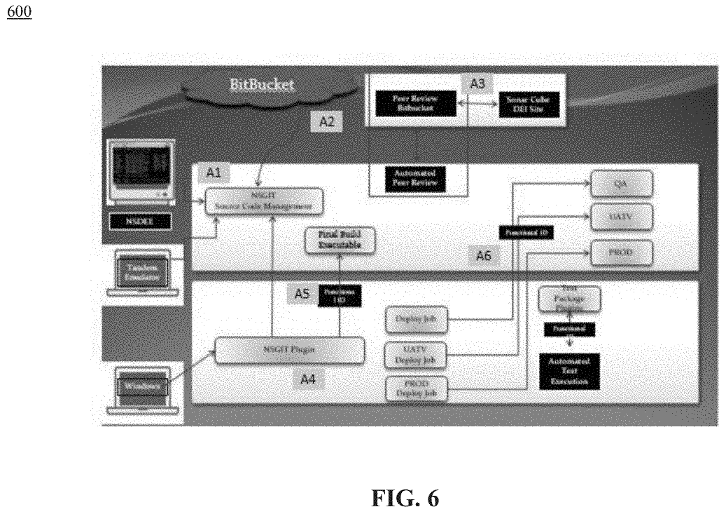

FIG. 6 is an architectural overview diagram 600 for a system for providing continuous integration and continuous deployment of applications within a platform that hosts a complex software suite, according to an exemplary embodiment.

Referring to FIG. 6, at A1, Source Code Build done in TANDEM box is pushed to Bitbucket by using the NSGit tool. The Data Definition Language (DDL) dictionaries and source code are pushed to Bitbucket through NSGit, which acts as a connectivity between Tandem Guardian and Git.

At A2, source code in Bitbucket is reviewed. When an approval is obtained, the source code is merged with the release branch. Prehook in Bitbucket helps to attain this feature.

At A3, the Posthook feature in Bitbucket facilitates a scan with Jules connectivity.

At A4, a NSGit plugin is set up in Jenkins, which facilitates connectivity with Tandem to run the desired macros.

At A5, Jenkins Pipeline is set up so that a timely trigger happens to run a macro present in the Tandem box to build the code and push the final executable module to Bitbucket.

At A6, Jenkins macro is then triggered to stage the final executable module to the Tandem box. Once staged, each target environment is prepared for deploying the code.

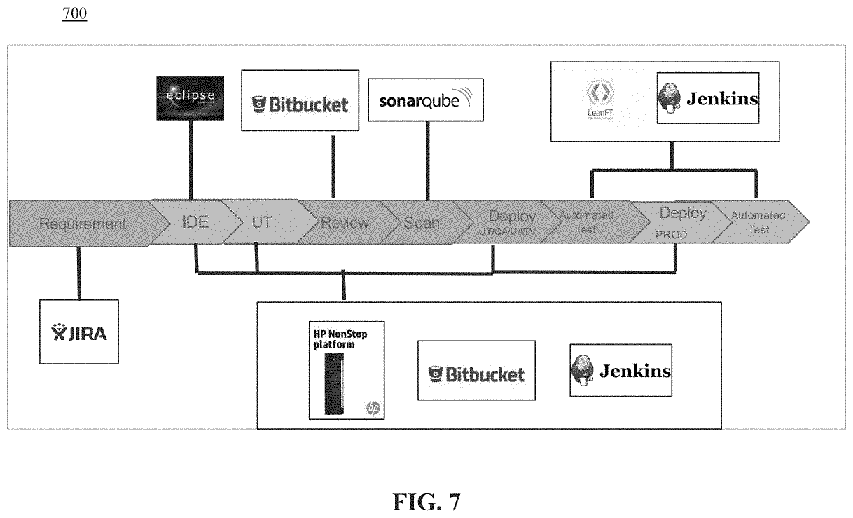

FIG. 7 is a data flow diagram 700 of a deployment pipeline that is usable for executing a method for providing continuous integration and continuous deployment of applications within a platform that hosts a complex software suite, according to an exemplary embodiment.

Referring to FIG. 7, in an exemplary embodiment, the Jenkins Pipeline 700 includes the following stages: 1) a Requirement stage that relates to requirements for a new software development task; 2) an Integrated Development Environment (IDS) stage that relates to developing the source code; 3) a User Testing (UT) stage that relates to user testing of the source code; 4) a Review stage that relates to a peer review process and obtaining approval for the source code; 5) a Scan stage; 6) an initial Deploy stage that relates to pre-production deployment; 7) an initial Automated Test stage that relates to pre-production testing; 8) a final Deploy stage that relates to production deployment; and 8) a final Automated Test stage that relates to post-production testing.

Accordingly, with this technology, an optimized process for providing continuous integration and continuous deployment of applications within a platform that hosts a complex software suite is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for integrating applications into a software suite, the method being implemented by at least one processor, the method comprising:
receiving, by the at least one processor, a first code set that corresponds to a first application;
obtaining, by the at least one processor, an approval that relates to the first code set;
compiling, by the at least one processor, the first code set in order to generate a module that is executable within the software suite;
determining, by the at least one processor, at least one target environment within the software suite for deployment of the first application;
deploying, by the at least one processor, the executable module to each of the at least one target environment; and
executing an automated testing procedure for administering a test with respect to the deployed module,
wherein the deploying of the executable module to each of the at least one target environment comprises deploying the executable module to a stage that relates to production deployment.

2. The method of claim 1, wherein the software suite is hosted on an HP NonStop platform.

3. The method of claim 1, wherein the deploying comprises using a Jenkins Pipeline to execute the deployment.

4. The method of claim 1, wherein the software suite is stored in a Bitbucket repository.

5. The method of claim 4, further comprising: after receiving the first code set and before obtaining the approval, using an NSGit tool to forward the received first code set to the Bitbucket repository.

6. The method of claim 5, wherein the obtaining of the approval comprises using the Bitbucket repository to facilitate a peer review process.

7. (canceled)

8. The method of claim 1, wherein the executing of the automated testing procedure comprises using a LeanFT tool to perform the execution of the automated testing procedure.

9. The method of claim 1, further comprising validating the deployed module based on a result of the execution of the automated testing procedure.

10. A computing apparatus for integrating applications into a software suite, the computing apparatus comprising:
a processor;
a memory; and
a communication interface coupled to each of the processor and the memory,
wherein the processor is configured to:
receive, via the communication interface, a first code set that corresponds to a first application;
obtain an approval that relates to the first code set;
compile the first code set in order to generate a module that is executable within the software suite;
determine at least one target environment within the software suite for deployment of the first application;
deploy the executable module to a stage that relates to production deployment within each of the at least one target environment; and
execute an automated testing procedure for administering a test with respect to the deployed module.

11. The computing apparatus of claim 10, wherein the software suite is hosted on an HP NonStop platform.

12. The computing apparatus of claim 10, wherein the processor is further configured to use a Jenkins Pipeline to execute the deployment.

13. The computing apparatus of claim 10, wherein the memory comprises a Bitbucket repository, and the software suite is stored in the Bitbucket repository.

14. The computing apparatus of claim 13, wherein the processor is further configured to: after receiving the first code set and before obtaining the approval, use an NSGit tool to forward the received first code set to the Bitbucket repository.

15. The computing apparatus of claim 14, wherein the processor is further configured to obtain the approval by using the Bitbucket repository to facilitate a peer review process.

16. (canceled)

17. The computing apparatus of claim 10, wherein the processor is further configured to use a LeanFT tool to perform the execution of the automated testing procedure.

18. The computing apparatus of claim 10, wherein the processor is further configured to validate the deployed module based on a result of the execution of the automated testing procedure.
